(19) United States
(12) Patent Application Publication
(10) Pub. No.: US 2012/0275735 A1
(43) Pub. Date: Nov. 1, 2012

(54) ROLLING BEARING

(75) Inventors: Motoharu AKIYAMA, NAGANO (JP); Yusuke ENOMOTO, NAGANO (JP)

(73) Assignee: MINEBEA CO., LTD., Nagano (JP)

(21) Appl. No.: 13/457,688

(22) Filed: Apr. 27, 2012

(30) Foreign Application Priority Data
Apr. 28, 2011 (JP) 2011-100431

(51) Int. Cl. F16C 33/66

(52) U.S. Cl. 384/462

(57) ABSTRACT

A rolling bearing is provided. The rolling bearing includes an inner ring, an outer ring, a plurality of rolling elements disposed in a space between the inner ring and the outer ring, and a grease composition enclosed in the space. The grease composition including (A) a lithium soap thickener, (B) a base oil which is an ester synthetic oil obtained by an esterification reaction of trimethylolpropane with a fatty acid; and (C) (c-1) a 1-naphthylamine antioxidant and (c-2) a diphenylamine antioxidant, a total amount of (c-1) and (c-2) ranging from 1.0 to 10 mass % based on an entire amount of the grease composition, and a blending ratio of (c-1) and (c-2) ranging from 30:70 to 70:30 in terms of mass ratio.

### BACKGROUND OF THE INVENTION

1. Field of the Invention

The present invention relates to a rolling bearing, in particular, a rolling hearing suitable for a small motor.

2. Description of the Related Art

Power saving and high durability are required for a small motor such as a brushless motor and a fan motor used in home electrical devices or information devices, and low noise, long acoustic life and the like are required for a rolling bearing used in such a small motor.

As a grease composition for achieving low noise and long acoustic life in a rolling bearing, there is known a grease composition prepared by incorporating a cleaning dispersant into grease with an attempt to prevent abrasion powder due to running-in wear from adhering to a rolling contact surface and thereby achieve low noise and long acoustic life (for example, refer to JP 4117445 B).

There is also known a grease composition in which a thickener composed of a urea compound having a specific composition and a specific organic sulfonate are combined, thereby making it possible to improve the initial acoustic characteristics and also prevent the acoustic characteristics from reducing with aging or reducing due to a temperature rise (for example, refer to JP 2008-143979 A).

In general, lithium soap-based grease is used for applications requiring acoustic characteristics such as low noise, and urea-based grease is used for applications requiring heat resistance. However, neither the lithium-based grease nor the urea-based grease can satisfy both heat resistance and long acoustic life, and therefore, a bearing having enclosed therein such grease has a problem that during use at a high temperature, the time period maintaining the initial acoustic characteristics would be shortened.

Accordingly, there is a strong demand for a rolling bearing capable of achieving a long acoustic life even when used in a high-temperature environment that is likely to be produced in a small motor or the like.

### SUMMARY OF THE INVENTION

The present invention has been made in view of the above circumstances, and an object of the present invention is to provide a rolling bearing having a heat-stable long acoustic life.

According to an illustrative embodiment of the present invention, there is provided a rolling bearing comprising ah inner ring, an outer ring, a plurality of rolling elements disposed in a space between the inner ring and the outer ring, and a grease composition enclosed in the space,

wherein the grease composition comprises:

(A) a lithium soap thickener;

(B) a base oil that is an ester synthetic oil obtained by an esterification reaction of trimethylolpropane with a fatty acid; and

(C) (c-1) a 1-naphthylamine antioxidant and (c-2) a diphenylamine antioxidant, a total amount of (c-1) and (c-2) raging from 1.0 to 10 mass % based on an entire amount of the grease composition, and a blending ratio of (c-1) and (c-2) ranging from 30:70 to 70:30 in terms of mass ratio.

In the above grease composition, (c-1) the 1-naphthylamine antioxidant may be a compound represented by the following formula (I):

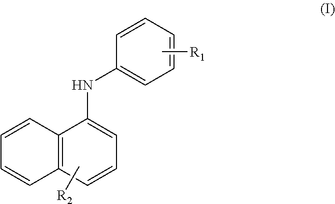

wherein in the formula (I), each of R1 and R2 are mutually independent and may be a hydrogen atom, or a linear or branched alkyl group having a carbon number of 1 to 12.

In the above grease composition, (c-2) the diphenylamine antioxidant may be a compound represented by the following formula (II):

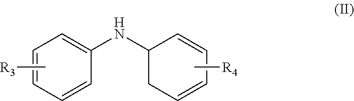

wherein in the formula (II) each of R3 and R4 are mutually independent and may be a hydrogen atom, or a linear or branched alkyl group having a carbon number of 1 to 12.

In the above grease composition, (B) the ester synthetic oil may be an ester oil obtained by an esterification reaction of trimethylolpropane with a mixture of linear and branched fatty acids each having a carbon number of 6 to 20.

In the above grease composition, (A) the lithium soap thickener may be lithium 12-hydroxystearate.

According to the above configuration, a rolling bearing having a heat-stable long acoustic life is provided.

### BRIEF DESCRIPTION OF THE DRAWINGS

FIG. 1 is a view showing a schematic configuration of a ball bearing according to an illustrative embodiment of the present invention.

### DETAILED DESCRIPTION

The configuration of a ball bearing according to an illustrative embodiment of the present invention is described in detail below by referring to the attached drawing.

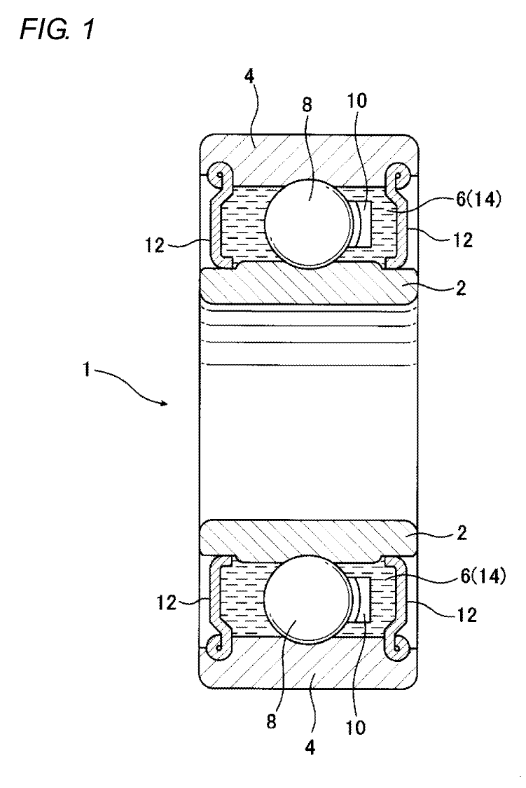

FIG. 1 is a cross-sectional view in a diameter direction of a ball bearing 1 according to an illustrative embodiment of the present invention. The ball bearing 1 has the same basic structure as a relate-art ball bearing and includes an annular inner ring 2 and an annular outer ring 4. The outer ring 4 has a larger diameter than the inner ring 2 and is disposed concentrically with the inner ring 2 to form an annular space 6 between the outer ring 4 and the inner ring 2.

In the annular space 6, an annular retainer 10 for holding a ball 8 is disposed. The retainer 10 has a plurality of concaves disposed at fixed intervals in the circumferential direction, and a ball 8 is housed in each concave. In each concave, the ball 8 is disposed to allow itself to contact the inner ring 2 at one side and the outer ring 4 at another side.

Furthermore, at both ends of the annular space 6 in the axis line direction, annular seal members 12, 12 are provided respectively, whereby the annular space is sealed in the axis line direction.

As a result, the annular space 6 becomes a closed space defined by the inner ring 2 in the radially inside direction, the outer ring 4 in the radially outside direction, and the annular seal members 12, 12 at both ends in the axis line direction. Each of the annular seal members 12, 12 is an annular member made of a steel sheet, and its outer edge part is attached to the outer ring 4.

In the ball bearing 1 of this illustrative embodiment, a grease composition 14 according to the later-described formulation is enclosed in the annular space 6. The amount of the grease composition enclosed is preferably in the order of 25 to 35% of the volume of the annular space 6.

The grease composition enclosed in the annular space 6 of the ball bearing 1 according to this illustrative embodiment is described below.

The grease composition used for the ball bearing 1 of this illustrative embodiment includes (A) a lithium soap thickener, (B) a base oil, and (C) an antioxidant, which are described below.

<Grease Composition>

[(A) Lithium Soap Thickener]

The lithium soap thickener used in the grease composition for the ball bearing 1 of this illustrative embodiment has fewer drawbacks and is not expensive and therefore, this is a practical thickener. The thickener is preferably lithium laurate, lithium stearate or lithium 12-hydroxystearate, more preferably lithium laurate or lithium 12-hydroxystearate, still more preferably lithium 12-hydroxystearate. The rolling bearing having enclosed therein a grease composition including the lithium soap thickener is excellent in the low noise property.

The consistency of the grease composition used for the ball bearing 1 of this illustrative embodiment is preferably from 200 to 400, and the content of the thickener is an amount necessary to obtain this consistency. The content is preferably from 3 to 30 mass %, more preferably from 5 to 20 mass %, and most preferably from 7 to 15 mass %, based on the entire grease composition.

[(B) Base Oil]

The base oil used in the grease composition for the ball bearing 1 of this illustrative embodiment is an ester synthetic oil obtained using trimethylolpropane as an alcohol. The fatty acid constituting the ester synthetic base oil includes a linear or branched fatty acid having a carbon number of 6 to 20, preferably from 6 to 18. The fatty acid may be a single fatty acid or a mixture of two or more fatty acids but is preferably a mixture. A mixture of a linear fatty acid and a branched fatty acid is more preferred, because as compared to a configuration using a linear fatty acid alone, a mixture with a branched fatty acid brings about excellent fluidity at a low temperature. The fatty acid may be either saturated or unsaturated but is preferably a saturated fatty acid.

Above all, an ester synthetic oil obtained from trimethylolpropane and a mixture of a linear saturated fatty acid having a carbon number of 6 to 12 and a branched saturated fatty acid having a carbon number of 16 to 18 is preferred, and an ester oil of trimethylolpropane with a mixture of n-octanoic acid, n-decanoic acid and i-stearic acid is most preferred.

The kinetic viscosity of the base oil at 40° C. is preferably from 10 to 50 mm²/s, more preferably from 15 to 35 mm²/s.

[(C) Antioxidant]

The grease composition used for the ball bearing 1 of this illustrative embodiment includes, as the essential component, (c-1) a 1-naphthylamine antioxidant and (c-2) a diphenylamine antioxidant.

The total amount of (c-1) and (c-2) ranges from 1.0 to 10 mass %, preferably from 2.0 to 6.0 mass %, based on the entire mass of the grease composition. When the total amount of (c-1) and (c-2) is in this range, the rolling bearing having enclosed therein the grease composition is excellent in the heat-stable acoustic life performance.

The blending ratio of (c-1) the 1-naphthylamine antioxidant and (c-2) the diphenylamine antioxidant ranges from 30:70 to 70:30 in terms of mass ratio. When the blending ratio of (c-1) and (c-2) is in this range, an excellent heat-stable acoustic life performance is obtained with a small added amount.

As (c-1) the 1-naphthylamine antioxidant, a compound represented by the following formula (I) is preferred:

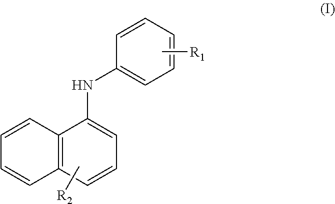

In this formula (I), each of R1 and R2 are mutually independent and may be a hydrogen atom, or a linear or branched alkyl group having a carbon number of 1 to 12.

Examples of the linear or branched alkyl group of R1 and R2 include methyl, ethyl, n-propyl, i-propyl, n-butyl, i-butyl, tert-butyl, n-pentyl, i-pentyl, neopentyl, tert-pentyl, 2-methylbutyl, n-hexyl, i-hexyl, 3-methylpentyl, ethylbutyl, n-heptyl, 2-methylhexyl, n-octyl, i-octyl, 2-ethylhexyl, 3-methylheptyl, 1,1,3,3-tetramethylbutyl, n-nonyl, i-nonyl, 1-methyloctyl, ethylheptyl, n-decyl, 1-methylnonyl, n-undecyl, 1,1-dimethylnonyl, and n-dodecyl.

R1 is preferably a hydrogen atom, and R2 is preferably a branched alkyl group having a carbon number of 1 to 12, more preferably a branched alkyl group having a carbon number of 3 to 10, still more preferably a 1,1,3,3-tetramethylbutyl group. It is yet still more preferred that R1 is a hydrogen atom and R2 is a 1,1,3,3-tetramethylbutyl group.

The bonding position of R1 is preferably the 4-position of the phenyl group. The bonding position of R2 is preferably the 6-position of the naphthyl group.

The compound of formula (I) is preferably N-phenyl-1,1,3,3-tetramethylbutylnaphthalene-1-amine.

In the grease composition of this illustrative embodiment, as the 1-naphthylamine antioxidant, one compound may be used alone, or two or more compounds may be used in appropriate combination.

As (c-2) the diphenylamine antioxidant, a compound represented by the following formula (II) is preferred:

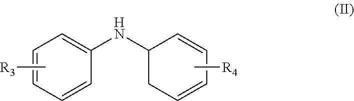

In the formula (II), each of R3 and R4 are mutually independent and may be a hydrogen atom, or a linear or branched alkyl group having a carbon number of 1 to 12.

Examples of the linear or branched alkyl group of R3 and R4 include methyl, ethyl, n-propyl, i-propyl, n-butyl, i-butyl, tert-butyl, n-pentyl, i-pentyl, neopentyl, tert-pentyl, 2-methylbutyl, n-hexyl, i-hexyl, 3-methylpentyl, ethylbutyl, n-heptyl, 2-methylhexyl, n-octyl, i-octyl, 2-ethylhexyl, 3-methylheptyl, 1,1,3,3-tetramethylbutyl, n-nonyl, i-nonyl, 1-methyloctyl, ethylheptyl, n-decyl, 1-methylnonyl, n-undecyl, 1,1-dimethylnonyl, and n-dodecyl.

The alkyl group represented by each of R3 and R4 can be bonded at an arbitrary position of the phenyl group but is preferably bonded at the p-position with respect to the amino group. More preferably, the compound is p,p′-dioctyldiphenylamine where each of R3 and R4 is an i-octyl group.

In the grease composition used for the ball bearing 1 of this illustrative embodiment, as the diphenylamine antioxidant, one compound may be used alone, or two or more compounds may be used in appropriate combination.

The grease composition for use in the ball bearing 1 of this illustrative embodiment may include, if appropriate, additives usually used for a grease composition, in addition to the above-described essential components. Examples of the additive include a rust inhibitor, a metal deactivator, a cleaning dispersant, an extreme-pressure additive, a defoaming agent, an anti-emulsifier, an oil improver, a wear inhibitor and a solid lubricant. The amount added of such an additive is usually from 0.01 to 10 mass %.

In particular, the ball bearing 1 of this illustrative embodiment is preferably used as a rolling bearing in a small motor (for example, a brushless motor or a fan motor) for a home appliance or an information device.

The present invention is not limited to the illustrative embodiment and specific working examples shown in the description of the present invention, and various changes and modifications can be made therein within the range of technical concept disclosed in the scope of claim for patent.

For example, in the illustrative embodiment above, a ball bearing is used as the rolling bearing, but the present invention is not limited thereto and can be applied to other rolling bearings or roller bearings.

### EXAMPLES

### Test Grease Used in Ball Bearing of Example

### Examples 1 to 5 and Comparative Examples 1 to 7

Lithium 12-hydroxystearate was mixed and dissolved under heating in the base oil shown in the Table 1 and then cooled to make a base grease. The antioxidant in a predetermined amount was mixed with the base oil, and this mixture was added to the base grease and sufficiently mixed. The resulting mixture was kneaded by a three-roll mill to produce a grease composition having a mixing consistency of 250 (JIS K2220).

### Comparative Example 8

In the base oil, cyclohexylamine and stearyl amine were reacted with diphenylmethane diisocyanate to prepare a base grease. The antioxidant in a predetermined amount was mixed with the base oil, and this mixture was added to the base grease and sufficiently mixed. The resulting mixture was kneaded by a three-roll mill to produce a grease composition having a mixing consistency of 250 (JIS K2220).

<Test Method>

### 1. Test Method for Initial Acoustic Performance and Heat-Stable Acoustic Life Performance

The test grease was enclosed in a ball bearing (inner diameter: 8 mm, outer diameter: 22 mm, width: 7 mm) with a steel shield in an amount of 25 to 35% of the bearing volume. This ball bearing was set in a housing by two and after applying a preload of about 40 N, a shaft was inserted into the inner diameter of the bearing. The shaft was connected to the rotary shaft of a test motor to rotate the inner ring of the ball bearing.

Subsequently, the ball bearing was put in a constant-temperature chamber, and an evaluation test was performed at a test temperature of 110° C. and a rotation speed of 3,000 rpm by performing rotation for 1,500 hours. Ten ball bearings were tested for each of Examples and Comparative Examples, and the average value was determined.

The acoustic performance before and after rotation of the bearing was evaluated by measuring the Anderon value of M band (300 to 1,800 Hz) with use of an Anderon meter. The initial acoustic performance was evaluated by the Anderon value before rotation of the ball bearing, and the heat-stable acoustic performance was evaluated by the Anderon value after rotation of the ball bearing for 1.500 hours. It is noted that the M band frequency of 300 to 1,800 Hz is considered a sound offensive to the human ear.

### 2. Evaluation Criteria of Initial Acoustic Performance

A: The average Anderon value was less than 0.3.

B: The average Anderon value was 0.3 or more.

### 3. Evaluation Criteria of Heat-Stable Acoustic Performance

A: The average Anderon value was less than 5.

B: The average Anderon value was 5 or more.

The results are shown in Table 1. In the Table, “mass %” is the value based on the total mass of the grease composition.

TABLE I

| | | Example 1 | Example 2 | Example 3 | Example 4 | Example 5 |
|---|---|---|---|---|---|---|
| Thickener | | Li 12- | Li 12- | Li 12- | Li 12- | Li 12- |
| | | Hydroxy- | Hydroxy- | Hydroxy- | Hydroxy- | Hydroxy- |
| | | stearate | stearate | stearate | stearate | stearate |
| Base oil | Ester Oil A | ∘ | ∘ | ∘ | ∘ | ∘ |
| | Ester Oil B | | | | | |
| Anti- | Antioxidant A (mass %) | 1.0 | 1.0 | 2.0 | 2.0 | 3.0 |
| oxidant | Antioxidant B (mass %) | 1.0 | 2.0 | 1.0 | 2.0 | 3.0 |
| | Antioxidant C (mass %) | | | | | |
| | A + B (mass %) | 2.0 | 3.0 | 3.0 | 4.0 | 6.0 |
| | A:B (mass ratio) | 50:50 | 33:67 | 67:33 | 50:50 | 50:50 |

| | | | | | |
|---|---|---|---|---|---|
| Initial acoustic performance | A | A | A | A | A |
| Heat-stable acoustic life | A | A | A | A | A |
| performance | | | | | |

| | | Comparative Example | | | | | | | |
|---|---|---|---|---|---|---|---|---|---|
| | | 1 | 2 | 3 | 4 | 5 | 6 | 7 | 8 |
| Thickener | | Li 12- | Li 12- | Li 12- | Li 12- | Li 12- | Li 12- | Li 12- | Urea |
| | | Hydroxy- | Hydroxy- | Hydroxy- | Hydroxy- | Hydroxy- | Hydroxy- | Hydroxy- | |
| | | stearate | stearate | stearate | stearate | stearate | stearate | stearate | |
| Base oil | Ester Oil A | ∘ | | ∘ | ∘ | ∘ | ∘ | ∘ | ∘ |
| | Ester Oil B | | ∘ | | | | | | |
| Anti- | Antioxidant A (mass %) | 2.0 | 1.0 | 0.3 | 7.0 | 0.4 | 1.6 | 4.0 | 2.0 |
| oxidant | Antioxidant B (mass %) | 0 | 1.0 | 0.3 | 7.0 | 1.6 | 0.4 | 0 | 2.0 |
| | Antioxidant C (mass %) | 1.0 | | | | | | | |
| | A + B (mass %) | 3 | 2.0 | 0.6 | 14.0 | 2.0 | 2.0 | 4.0 | 4.0 |
| | A:B (mass ratio) | — | 50:50 | 50:50 | 50:50 | 20:80 | 80:20 | — | 50:50 |

| | | | | | | | | |
|---|---|---|---|---|---|---|---|---|
| Initial acoustic performance | A | A | A | B | A | A | A | A |
| Heat-stable acoustic life | B | B | B | — | B | B | B | B |
| performance | | | | | | | | |

Base Oil:
Ester Oil A: An ester oil of trimethylolpropane with a mixture of n-octanoic acid, n-decanoic acid and i-stearic acid (kinematic viscosity at 40° C.: 25 mm2/s)
Ester Oil B: Pentaerythritol ester oil + diester (kinematic viscosity at 40° C.: 25 mm2/s)
The kinematic viscosity at 40° C. was measured in accordance with JIS K 2220 23.
Antioxidant:
Antioxidant A: Alkylated N-phenyl-1-naphthylamine (Cas No. 68259-36-9)
Antioxidant B: Alkylated diphenylamine (Cas No. 68411-46-1)
Antioxidant C: Hindered phenol-based (Cas No. 2082-79-3)

In all of Examples 1 to 5 where a grease composition obtained by using a lithium soap thickener, an ester synthetic base oil obtained by an esterification reaction of trimethylolpropane with a fatty acid (Ester Oil A), 1-naphthylamine (Antioxidant A) and diphenylamine (Antioxidant B) each in a predetermined amount and combining these in a predetermined ratio was enclosed, the initial acoustic performance was good, and the heat-stable acoustic life performance was also good.

In Comparative Example 1 where a grease composition obtained by blending the same amount of Antioxidant C in place of Antioxidant B in Example 3 was enclosed, the heat-stable acoustic life performance was poor.

In Comparative Example 2 (blending of Ester Oil B) where a grease composition obtained by blending a base oil different from that in Example 1 was enclosed, the heat-stable acoustic life performance was poor.

In Comparative Example 3 (blending of Antioxidant A and Antioxidant B in a total amount of 0.6 mass %) where a grease composition obtained by blending Antioxidants A and B in an amount smaller than that specified in the present invention was enclosed, the heat-stable acoustic life performance was poor.

In Comparative Example 4 (blending of Antioxidant A and Antioxidant B in a total amount of 14 mass %) where a grease composition obtained by blending Antioxidants A and B in an amount larger than that specified in the present invention was enclosed, the initial acoustic performance was poor.

In both of Comparative Example 5 (blending of 0.4 mass % of Antioxidant A and 1.6 mass % of Antioxidant B) and Comparative Example 6 (blending of 1.6 mass % of Antioxidant A and 0.4 mass % of Antioxidant B), where a grease composition obtained by blending Antioxidants A and B in the same total amount as in Example 1 but in a ratio out of the range specified in the present invention was enclosed, the heat-stable acoustic life performance was poor.

In Comparative Example 7 (blending of Antioxidant A) where a grease composition obtained by blending the antioxidant in the same amount as in Example 4 but not blending Antioxidant B was enclosed, the heat-stable acoustic life performance was poor.

In Comparative Example 8 (urea) where a grease composition obtained by blending a thickener different from that in Example 4 was enclosed, the heat-stable acoustic life performance was poor.

These results reveal that the rolling bearing having enclosed therein the grease composition of the present invention has both excellent initial acoustic performance and excellent heat-stable acoustic life performance.

What is claimed is:

1. A rolling bearing comprising an inner ring, an outer ring, a plurality of rolling elements disposed in a space between the inner ring and the outer ring, and a grease composition enclosed in the space,
wherein the grease composition comprises:
(A) a lithium soap thickener;
(B) a base oil which is an ester synthetic oil obtained by an esterification reaction of trimethylolpropane with a fatty acid; and
(C) (c-1) a 1-naphthylamine antioxidant and (c-2) a diphenylamine antioxidant, a total amount of (c-1) and (c-2) raging from 1.0 to 10 mass % based on an entire amount of the grease composition, and a blending ratio of (c-1) and (c-2) ranging from 30:70 to 70:30 in terms of mass ratio.

2. The rolling bearing according to claim 1.
wherein (c-1) the 1-naphthylamine antioxidant is a compound represented by the following formula (I): 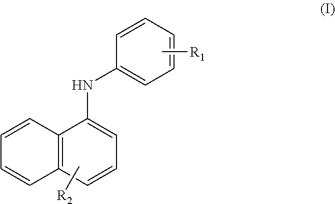
wherein in the formula (I), each of R1 and R2 are mutually independent and are a hydrogen atom, or a linear or branched alkyl group having a carbon number of 1 to 12.

3. The rolling bearing according to claim 1,
wherein (c-2) the diphenylamine antioxidant is a compound represented by the following formula (II): 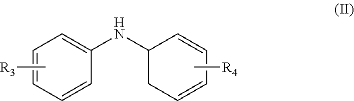
wherein in the formula (II), each of R3 and R4 are mutually independent and are a hydrogen atom, or a linear or branched alkyl group having a carbon number of 1 to 12.

4. The rolling bearing according to claim 1,
wherein (B) the ester synthetic oil is an ester oil obtained by an esterification reaction of trimethylolpropane with a mixture of linear and branched fatty acids each having a carbon number of 6 to 20.

5. The rolling bearing according to claim 1,
wherein (A) the lithium soap thickener is lithium 12-hydroxystearate.
